(19) United States
(12) Patent Application Publication
(10) Pub. No.: US 2020/0295480 A1
(43) Pub. Date: Sep. 17, 2020

(54) ELECTRICAL CONNECTOR AND METHOD OF MANUFACTURING SAME

(71) Applicant: LOTES CO., LTD., Keelung (TW)

(72) Inventor: Yu Sheng Chen, Keelung (TW)

(21) Appl. No.: 16/778,010

(22) Filed: Jan. 31, 2020

(30) Foreign Application Priority Data
Mar. 15, 2019 (CN) 201910196243.X

(51) Int. Cl. H01R 12/58; H01R 12/70; H01R 12/57; H01R 13/24; H01R 12/71; H01R 13/504

(52) U.S. Cl. CPC H01R 12/58; H01R 12/7076; H01R 13/504; H01R 13/24; H01R 12/716; H01R 12/57

(57) ABSTRACT

A method of manufacturing an electrical connector is provided. A substrate is provided with multiple conductive portions and multiple through holes running through the substrate vertically. The substrate is disposed in a mold, and then a liquid plastic is injected into the mold. The liquid plastic flows into the through holes. The liquid plastic forms a connecting member located below the substrate and multiple support members integrally connected by the connecting member after cooling. The support members are correspondingly accommodated in the through holes and protrude upward out of the substrate. The substrate, the support members and the connecting member are taken out from the mold. Multiple first terminals are formed. Each first terminal has a first conducting portion and a first contact portion to be upward conductively connected to a chip module. The first conducting portions of the first terminals are downward conductively connected to the conductive portions correspondingly.

### CROSS-REFERENCE TO RELATED PATENT APPLICATION

This non-provisional application claims priority to and the benefit of, pursuant to 35 U.S.C. § 119(a), patent application Serial No. CN 201910196243.X filed in China on Mar. 15, 2019. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector and a method of manufacturing the same, and particularly to an electrical connector in which multiple support members are integrally formed and a method of manufacturing the same.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An electrical connector for being connected to a chip module includes a substrate and multiple conductive terminals fixed on the substrate. One end of each conductive terminal is soldered on a circuit board by a solder ball, and the other end thereof abuts an electrical conductor of the chip module, thereby realizing electrical conduction between the chip module and the circuit board. Multiple through holes are provided in the middle of the substrate, and multiple support members are correspondingly assembled to the through holes to support the chip module.

A disadvantage of the related art exists in that the support members of the electrical connector are assembled one-by-one onto the substrate. Thus, time is wasted, work efficiency is low, and cost is increased.

Therefore, a heretofore unaddressed need to design a new electrical connector and a method of manufacturing the same exists in the art to address the aforementioned deficiencies and inadequacies.

### SUMMARY

In view of the background art, the present invention is directed to an electrical connector in which multiple support members are integrally formed and a method of manufacturing the same.

To achieve the foregoing objective, the present invention adopts the following technical solutions.

An electrical connector configured to be electrically connected to a first mating component includes: a substrate, provided with a plurality of conductive portions and a plurality of through holes, wherein the through holes run through the substrate vertically; a plurality of first terminals, wherein each of the first terminals is provided with a first conducting portion and a first contact portion, the first conducting portion is downward conductively connected to a corresponding one of the conductive portions, and the first contact portion is located above the substrate to be conductively connected to the first mating component; a plurality of support members, integrally injection-molded on the substrate and correspondingly accommodated in the through holes, wherein the support members protrude upward out of the substrate to support the first mating component; and a connecting member, integrally connected to the support members, wherein the connecting member is located below the substrate.

In certain embodiments, each of the support members comprises a first portion and a second portion connected to each other, the first portion is accommodated in a corresponding one of the through holes, and the second portion is located above the substrate and pressed downward on the substrate.

In certain embodiments, an upper surface of the substrate is downward concavely provided with a plurality of grooves, a groove wall of each of the grooves is provided with one of the conductive portions, and the first conducting portion of each of the first terminals is a fisheye structure inserted into a corresponding one of the grooves to be electrically connected to the corresponding one of the conductive portions.

In certain embodiments, the electrical connector further includes a plurality of second terminals, wherein each of the second terminals is provided with a second conducting portion and a second contact portion, the conductive portions are respectively exposed upward and downward on the substrate, the second conducting portion is upward conductively connected to a corresponding one of the conductive portions, and the second contact portion is located below the substrate to be downward conductively connected to a second mating component.

In certain embodiments, the substrate is provided with a plurality of grooves running through the substrate vertically, a groove wall of each of the grooves is provided with one of the conductive portions, the first conducting portion of each of the first terminals is inserted downward into a corresponding one of the grooves and electrically connected to the corresponding one of the conductive portions, and the second conducting portion of each of the second terminals is inserted upward into a corresponding one of the grooves and electrically connected to the corresponding one of the conductive portions.

In certain embodiments, each of the first terminals comprises a first main body portion and a first elastic arm extending forward from the first main body portion, the first elastic arm is provided with the first contact portion, and the first conducting portion extends downward from the first main body portion; and each of the second terminals comprises a second main body portion and a second elastic arm extending forward from the second main body portion, the second elastic arm is provided with the second contact portion, and the second conducting portion extends upward from the second main body portion.

In certain embodiments, one of the first terminals and one of the second terminals connected to a same one of the conductive portions are provided to be vertically symmetrical.

In certain embodiments, the first terminals include at least one ground terminal and at least one signal terminal, and the at least one ground terminal and the at least one signal terminal have identical structures.

Compared with the related art, the electrical connector according to certain embodiments of the present invention has the following beneficial effects.

The support members are integrally injection-molded on the substrate. The support members protrude upward out of the substrate to support the first mating component. The connecting member is integrally connected to the support members, and the connecting member is located below the substrate. Thus, the support members integrally connected by the connecting member are integrally formed on the substrate, such that the support members can be provided on the substrate at a time, thereby eliminating the time for implanting the support members one-by-one, reducing the cost and enhancing the work efficiency.

An electrical connector configured to be electrically connected to a first mating component includes: a substrate, provided with a plurality of conductive portions and a plurality of through holes, wherein the through holes run through the substrate vertically; a plurality of first terminals, wherein each of the first terminals is provided with a first conducting portion and a first contact portion, the first conducting portion is downward conductively connected to a corresponding one of the conductive portions, and the first contact portion is located above the substrate to be conductively connected to the first mating component; and a plurality of support members, integrally injection-molded on the substrate, wherein each of the support members has a first portion, and a second portion and a position limiting portion connected to an upper end and a lower end of the first portion, the first portion is accommodated in a corresponding one of the through holes, the second portion protrudes upward out of the substrate to support the first mating component, the position limiting portion is located below the substrate, and the second portion and the position limiting portion respectively abut the substrate in a vertical direction.

Compared with the related art, the electrical connector according to certain embodiments of the present invention has the following beneficial effects.

The support members are integrally injection-molded on the substrate. Thus, the support members are integrally formed on the substrate, such that the support members can be provided on the substrate at a time, thereby eliminating the time for implanting the support members one-by-one, reducing the cost and enhancing the work efficiency. The second portion and the position limiting portion of each support member respectively abut the substrate in the vertical direction, thereby preventing the support member from being detached from the substrate upward or downward.

A method of manufacturing an electrical connector configured to be electrically connected to a first mating component includes: step S1: providing a substrate, wherein the substrate is provided with a plurality of conductive portions and a plurality of through holes, and the through holes run through the substrate vertically; step S2: disposing the substrate in a mold, and then injecting a liquid plastic into the mold, wherein the liquid plastic flows into the through holes, the liquid plastic forms a connecting member and a plurality of support members integrally connected by the connecting member after cooling, the support members are correspondingly accommodated in the through holes and protrude upward out of the substrate, and the connecting member is located below the substrate; step S3: taking the substrate, the support members and the connecting member out from the mold; and step S4: providing a plurality of first terminals, wherein each of the first terminals is provided with a first conducting portion and a first contact portion configured to be upward conductively connected to the first mating component; and making the first conducting portions of the first terminals to be downward conductively connected to the conductive portions correspondingly.

In certain embodiments, in the step S1, an insulating member is attached below the substrate, the insulating member comprises a plurality of through slots, each of the through slots runs through the insulating member vertically, the through slots correspond to the through holes vertically, and the insulating member shields the conductive portions.

In certain embodiments, after the step S3 and prior to the step S4, the insulating member and the connecting member are removed such that the connecting member is disconnected from the support members.

In certain embodiments, in the step S2, the mold comprises an upper mold, a lower mold and a cavity, the substrate is placed into the cavity, the upper mold and the lower mold are closed together, the mold shields each of the conductive portions, the cavity is in communication with each of the through holes, and the liquid plastic forms the connecting member and the support members in the cavity after cooling.

In certain embodiments, in the step S2, after the liquid plastic is cooled, a first portion is formed in each of the through holes, a second portion is formed above the substrate corresponding to each of the through holes, a position limiting portion is formed below the substrate corresponding to each of the through holes, the second portion and the position limiting portion are integrally connected to an upper end and a lower end of the first portion, and the second portion and the position limiting portion respectively abut the substrate in a vertical direction; and after the step S3 and prior to the step S4, the connecting member is removed, such that the connecting member is disconnected from the support members.

In certain embodiments, in the step S1, the substrate is formed with a plurality of grooves running through the substrate vertically, and a groove wall of each of the grooves is provided with one of the conductive portions; and in the step S4, a plurality of second terminals are provided, each of the second terminals is provided with a second conducting portion and a second contact portion configured to be downward conductively connected to a second mating component, and the first conducting portions of the first terminals and the second conducting portions of the second terminals are respectively inserted into the grooves and are in contact with the conductive portions to form electrical connections.

Compared with the related art, the method according to certain embodiments of the present invention has the following beneficial effects.

By disposing the substrate in a mold, and then injecting a liquid plastic into the mold, the liquid plastic flows into the through holes, the liquid plastic forms a connecting member and a plurality of support members integrally connected by the connecting member after cooling, the support members are correspondingly accommodated in the through holes and protrude upward out of the substrate, and the connecting member is located below the substrate. Thus, the support members can be provided on the substrate at a time, thereby eliminating the time for implanting the support members one-by-one, reducing the cost and enhancing the work efficiency. The second portion and the position limiting portion of each support member respectively abut the substrate in the vertical direction, thereby preventing the support member from being detached from the substrate upward or downward.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of an electrical connector according to a first embodiment of the present invention.

FIG. 2 is a sectional view of the electrical connector in FIG. 1 after being assembled and mated with first and second mating components.

FIG. 3 is a partial sectional perspective view of the electrical connector in FIG. 1 being inverted after being assembled.

FIG. 4 is a partial sectional perspective view of a substrate and an insulating member being separated according to the first embodiment of the present invention.

FIG. 5 is a partial sectional perspective view of the insulating member after being mounted to the substrate in FIG. 4.

FIG. 6 is a perspective view of FIG. 5 being inverted.

FIG. 7 is a schematic view of the structure of FIG. 6 being disposed into a cavity of a mold.

FIG. 8 is a partial sectional perspective view of an injection-molded member being formed after a liquid plastic is injected and cooled in FIG. 7.

FIG. 9 is a partial sectional perspective view of FIG. 8 being inverted.

FIG. 10 is a perspective view of multiple support members integrally connected by a connecting member in FIG. 9.

FIG. 11 is a perspective view of the connecting member being disconnected from the support members in FIG. 10.

FIG. 12 is a partial sectional perspective view of FIG. 8 after the connecting member and the insulating member are removed.

FIG. 13 is a perspective view of FIG. 12 being inverted.

FIG. 14 is a perspective view of FIG. 12 after conductive terminals are assembled thereto.

FIG. 15 is a schematic view of a substrate being inverted and then disposed in a mold according to a second embodiment of the present invention.

FIG. 16 is a perspective view of an injection-molded member being formed after a liquid plastic is injected and cooled in FIG. 15.

FIG. 17 is a perspective view of FIG. 16 after a flow gate material is removed.

FIG. 18 is a perspective view of multiple support members being integrally connected by a connecting member according to a third embodiment of the present invention.

FIG. 19 is a perspective view of the connecting member being disconnected from the support members FIG. 18 being inverted.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

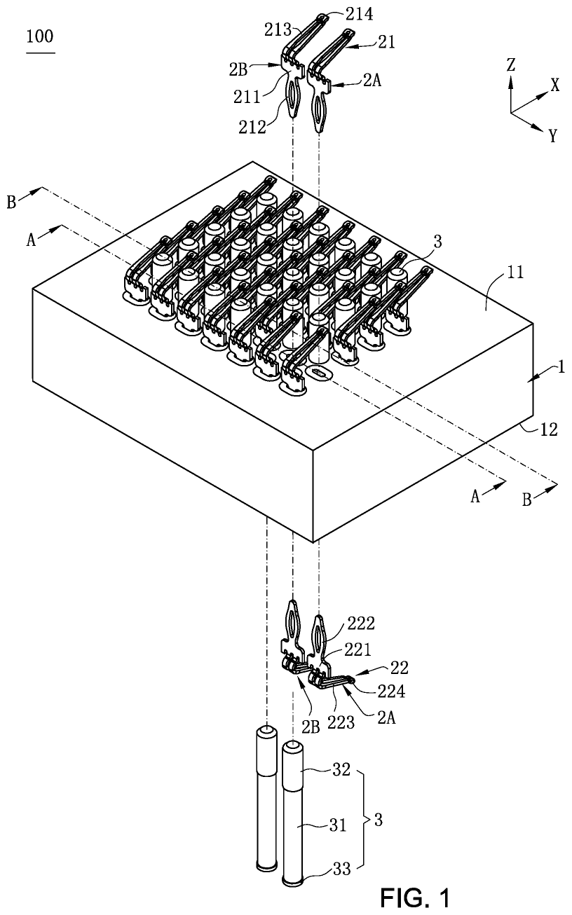

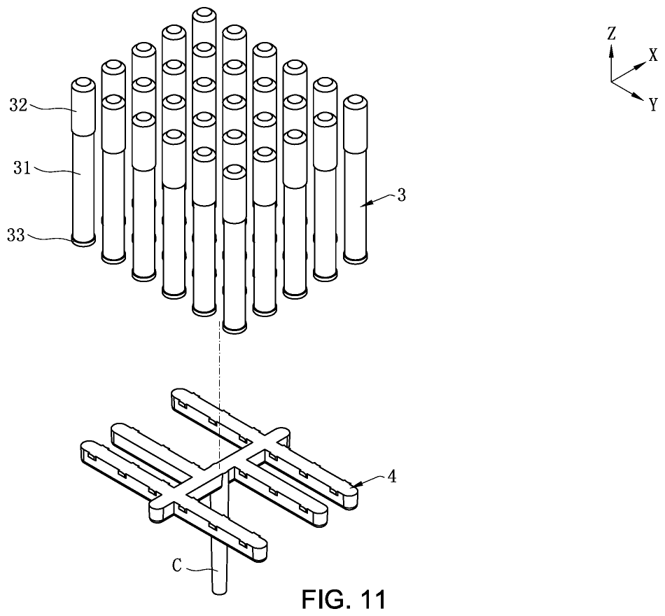

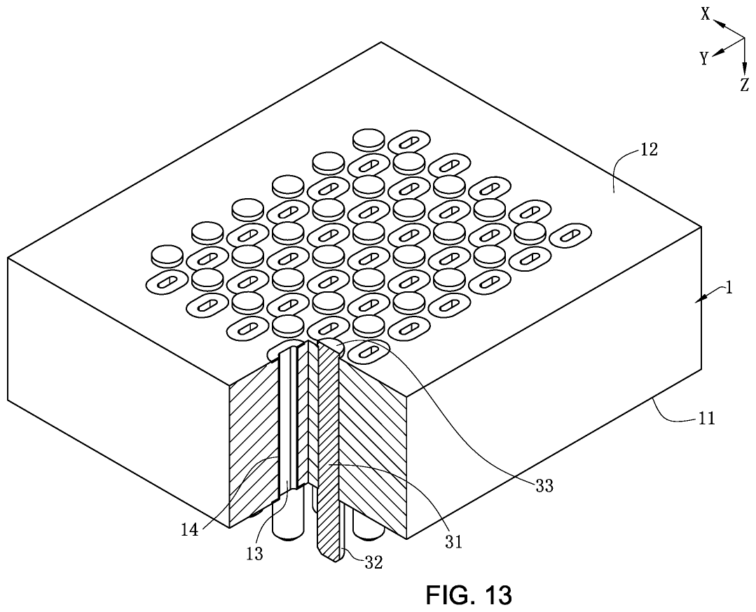

The description will be made as to the embodiments of the present invention in conjunction with the accompanying drawings in FIGS. 1-19. In accordance with the purposes of this invention, as embodied and broadly described herein, this invention, in one aspect, relates to an electrical connector and a method of manufacturing the same.

As shown in FIG. 1, an electrical connector 100 according to a first embodiment of the present invention is provided. The electrical connector 100 defines a vertical direction Z, and a front-rear direction X and a left-right direction Y perpendicular to the vertical direction Z and perpendicular to each other.

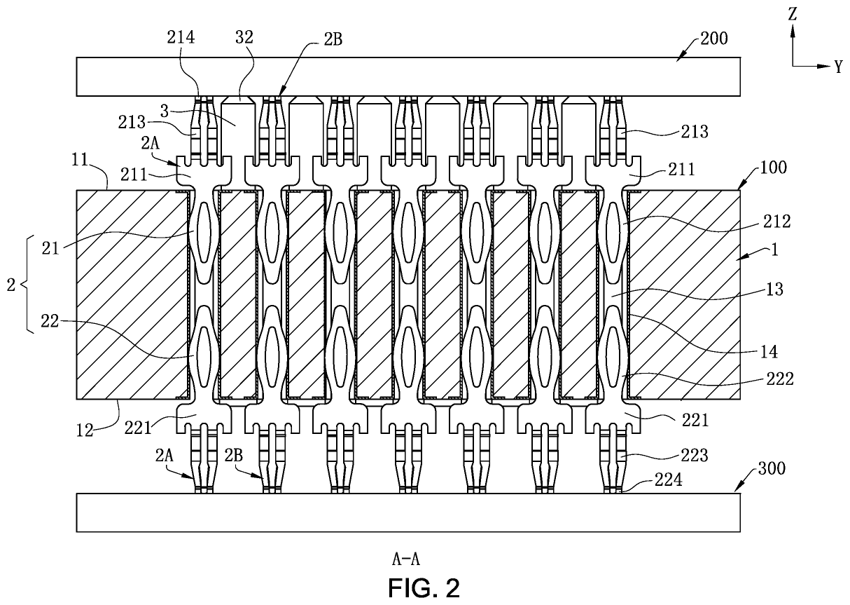

As shown in FIG. 1 and FIG. 2, the electrical connector 100 is used to connect a first mating component 200 and a second mating component 300, and mainly includes a substrate 1, and multiple conductive terminals 2 and multiple support members 3 provided on the substrate 1. In this embodiment, the first mating component 100 is a chip module, the substrate 1 is a circuit board, and the second mating component 300 is also a circuit board. In other embodiments, the first mating component 200 and the second mating component 300 may also be other types of components.

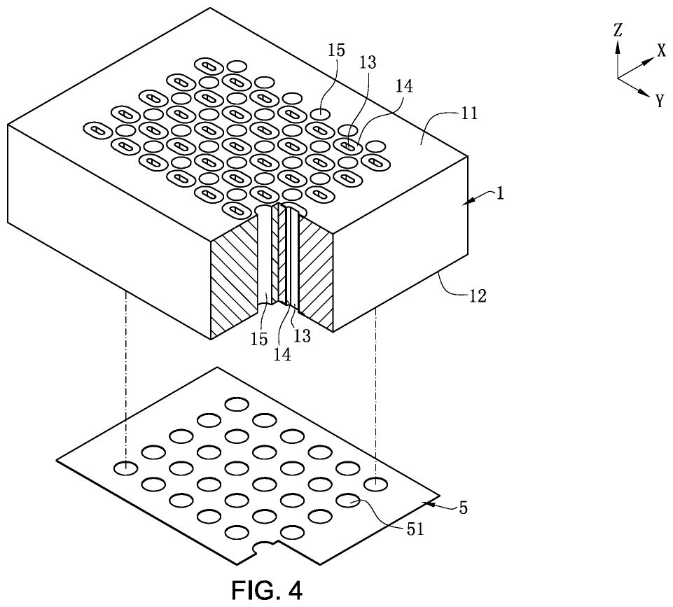

As shown in FIG. 1, FIG. 2 and FIG. 4, the substrate 1 may be a conventional printed circuit board material. The substrate 1 has an upper surface 11 and a lower surface 12 provided opposite to each other, and multiple grooves 13 running through the upper surface 11 and the lower surface 12. The substrate 1 is provided with multiple conductive portions 14, each being provided on a groove wall of each groove 13. The conductive portions 14 are made of a metal material, and the conductive portions 14 extends to the upper surface 11 and the lower surface 12. The substrate 1 further has multiple through holes 15 running vertically therethrough. In this embodiment, the cross section of each of the through holes 15 in a horizontal direction is circular. The grooves 13 and the through holes 15 are respectively arranged in multiple rows in the front-rear direction X. The rows of grooves 13 and the rows of through holes 15 are staggered in the front-rear direction X, and the grooves 13 and the through holes 15 in adjacent rows are staggered in the left-right direction Y. In other embodiments, the grooves 13 and the through holes 15 may be arranged in other manners.

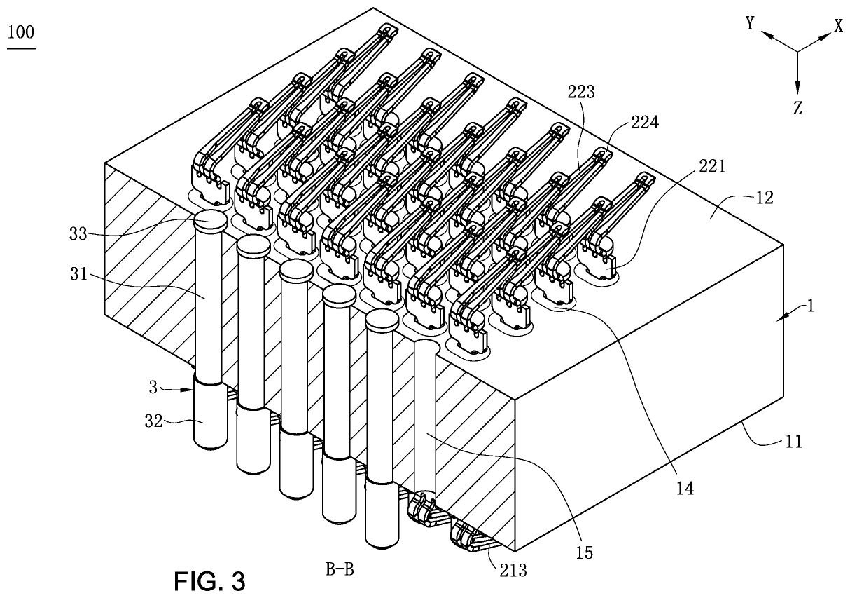

As shown in FIG. 1, FIG. 2 and FIG. 3, the conductive terminals 2 are made of a metal material. The conductive terminals 2 include multiple first terminals 21 and multiple second terminals 22. The first terminals 21 are provided above the substrate 1, and the second terminals 22 are provided below the substrate 1.

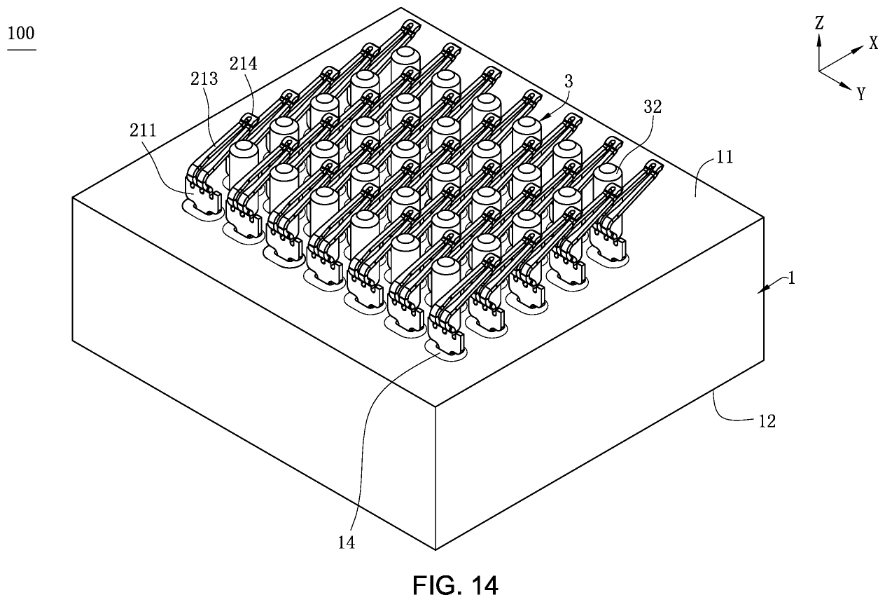

As shown in FIG. 1, FIG. 2 and FIG. 14, each first terminal 21 includes a first main body portion 211, a first conducting portion 212 extending downward from a lower end of the first main body portion 211, and a first elastic arm 213 extending forward and upward from an upper end of the first main body portion 211. The first elastic arm 213 is provided with a first contact portion 214, and the first conducting portion 212 has a fisheye structure. The first conducting portions 212 of the first terminals 21 are correspondingly inserted downward into the grooves 13. Each first conducting portion 212 is conductively connected to a corresponding conductive portion 14 to form an electrical connection. The first contact portion 214 is located above the substrate 1 to be upward conductively connected to the first mating component 200.

As shown in FIG. 1, FIG. 2 and FIG. 3, each second terminal 22 includes a second main body portion 221, a second conducting portion 222 extending upward from an upper end of the second main body portion 221, and a second elastic arm 213 extending forward and downward from a lower end of the second main body portion 221. The second elastic arm 223 is provided with a second contact portion 224, and the second conducting portion 222 also has a fisheye structure. The second conducting portions 222 of the second terminals 22 are correspondingly inserted upward into the grooves 13. Each second conducting portion 222 is conductively connected to a corresponding conductive portion 14 to form an electrical connection. The second contact portion 224 is located below the substrate 1 to be downward conductively connected to the second mating component 300.

As shown in FIG. 1 and FIG. 2, in this embodiment, the first terminals 21 and the second terminals 22 have identical structures. The first terminals 21 and the second terminals 22 respectively include at least one ground terminal 2A and at least one signal terminal 2B. The first terminals 21 and the second terminals 22 of the same type are connected to the same conductive portion 14, and the first terminal 21 and the second terminal 22 conductively connected to the same conductive portion 14 are provided to be vertically symmetrical.

As shown in FIG. 1, FIG. 2 and FIG. 14, the support members 3 are integrally formed from a liquid plastic in the through holes 15, and protrude out of the upper surface 11 to support the first mating component 200 upward. Each conductive terminal 2 and each support member 3 are staggered both in the front-rear direction X and in the left-right direction Y.

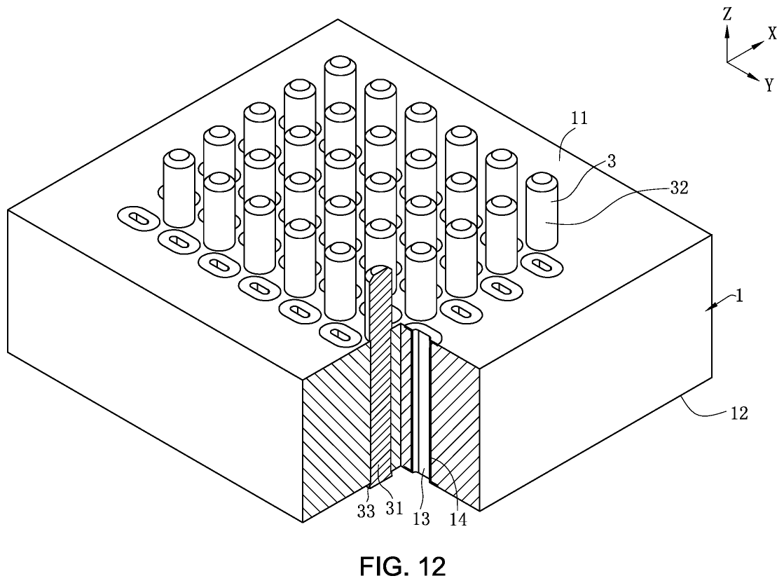

As shown in FIG. 1, FIG. 3 and FIG. 12, each support member 3 is substantially a cylindrical structure. Each support member 3 has a first portion 31, and a second portion 32 and a position limiting portion 33 connected to an upper end and a lower end of the first portion 31. The first portion 31 is accommodated in a corresponding through hole 15. The second portion 32 protrudes upward out of the upper surface 11 to support the first mating component 200. The position limiting portion 33 is located below the substrate 1 and upward abuts the lower surface 12. The second portion 32 downward abuts the upper surface 11. In other words, the size of the second portion 32 and the size of the position limiting portion 33 are respectively larger than a diameter of each through hole 15, such that each support member 3 can be limited from moving vertically relative to the substrate 1, thereby preventing the support members 3 from being detached from the substrate 1.

FIG. 4 to FIG. 14 show a method of manufacturing the electrical connector 100 according to the first embodiment of the present invention, which includes the following steps:

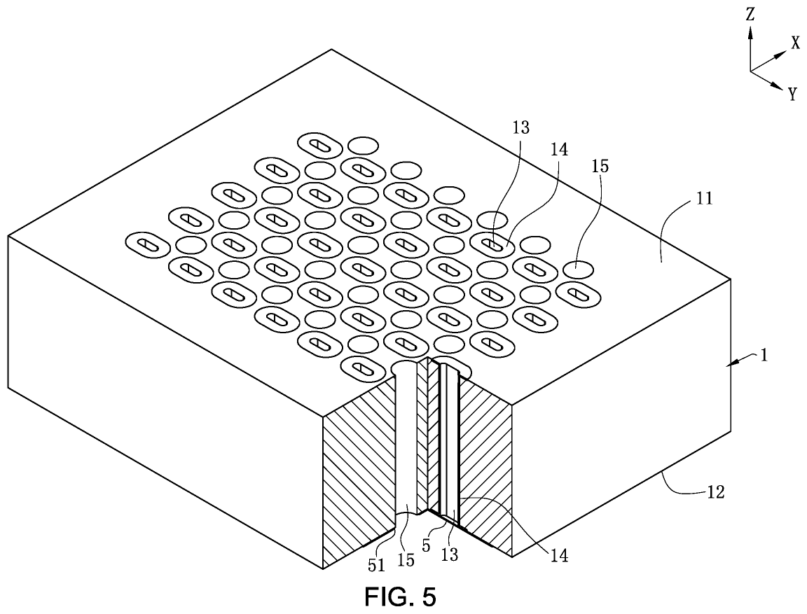

As shown in FIG. 4 and FIG. 5, in step S1, the grooves 13 and the through holes 15 are formed in the substrate 1 running vertically therethrough, and the groove wall of each groove 13 is provided with the corresponding conductive portion 14. The conductive portions 14 and the through holes 15 are arranged in multiple rows and multiple columns.

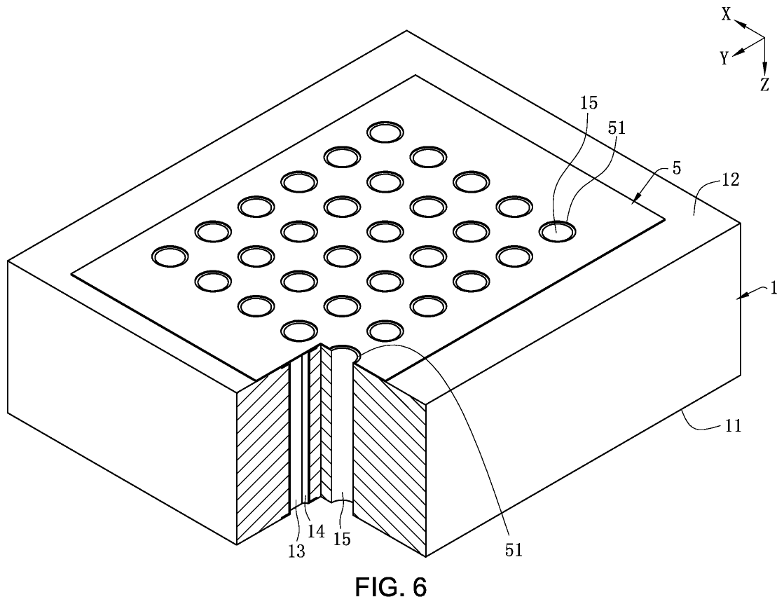

As shown in FIG. 4, FIG. 5 and FIG. 6, in the step S1, an insulating member 5 is attached to the lower surface 12 of the substrate 1. The insulating member 5 includes multiple through slots 51, and each through slot 51 runs through the insulating member 5 vertically. The through slots 51 correspond to the through holes 15 vertically. Each through slot 51 also has a cylindrical structure. A diameter of each through slot 51 is larger than the diameter of each through hole 51. The insulating member 5 shields the conductive portions 14.

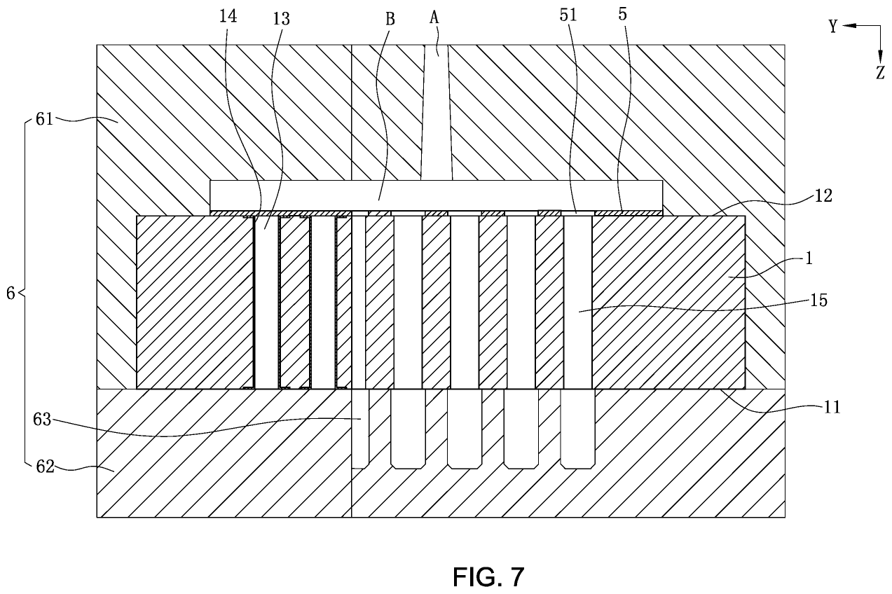

As shown in FIG. 7, in step S2, the substrate 1 and the insulating member 5 provided on the lower surface 12 of the substrate 1 are turned upside down and disposed in a mold 6 altogether. The mold 6 includes an upper mold 61, a lower mold 62 and a cavity 63. The mold 6 further includes a flow gate A and a runner B provided in the upper mold 61. The opening of the flow gate A gradually increases downward from top thereof in the upper mold 61. The flow gate A is downward in communication with the runner B, and the runner B is in communication with the cavity 63. After the upper mold 61 and the lower mold 62 are closed together, the substrate 1 is located in the cavity 63, and the runner B is provided above the inverted substrate 1. A portion of the cavity 63 is located below the inverted substrate 1, and the other portion thereof is correspondingly located above the through holes 15. The runner B is provided with multiple left-right runners and a front-rear runner in communication with the left-right runners. The flow gate A is in downward communication with the front-rear runner. Each left-right runner is provided between two adjacent rows of the through holes 15 at intervals in the front-rear direction X, and is in communication with the cavity 63 in the front-rear direction X. The upper mold 61 and the insulating member 5 are superposed vertically to jointly shield each conductive portion 14 downward from the upper side of the inverted substrate 1, and the lower mold 62 shields the conductive portions 14 upward from the lower side of the inverted substrate 1. The cavity 63 is in communication with each through hole 15.

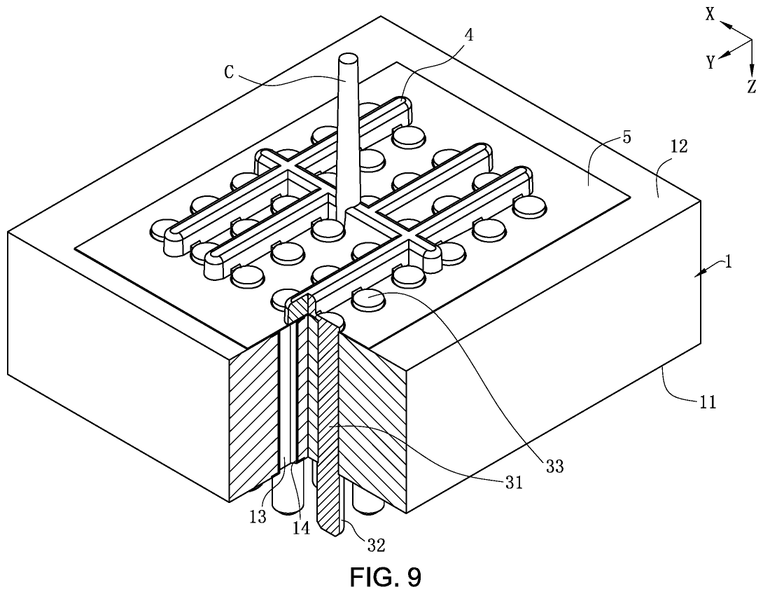

As shown in FIG. 7 and FIG. 9, a liquid plastic is then injected into the mold 6. The liquid plastic flows from the flow gate A into the runner B, the through holes 15 and the cavity 63. The liquid plastic, after cooling, forms a connecting member 4, the support members 3 integrally connected by the connecting member 4, and a flow gate material C integrally connected to the connecting member 4. At this time, the support members 3 are correspondingly accommodated in the through holes 15 and protrude downward out of the upper surface 11 of the inverted substrate 1. After the liquid plastic is cooled, the connecting member 4 is formed in the runner B, and the flow gate material C is formed in the flow gate A. The connecting member 4 and the flow gate material C are both located above the inverted substrate 1.

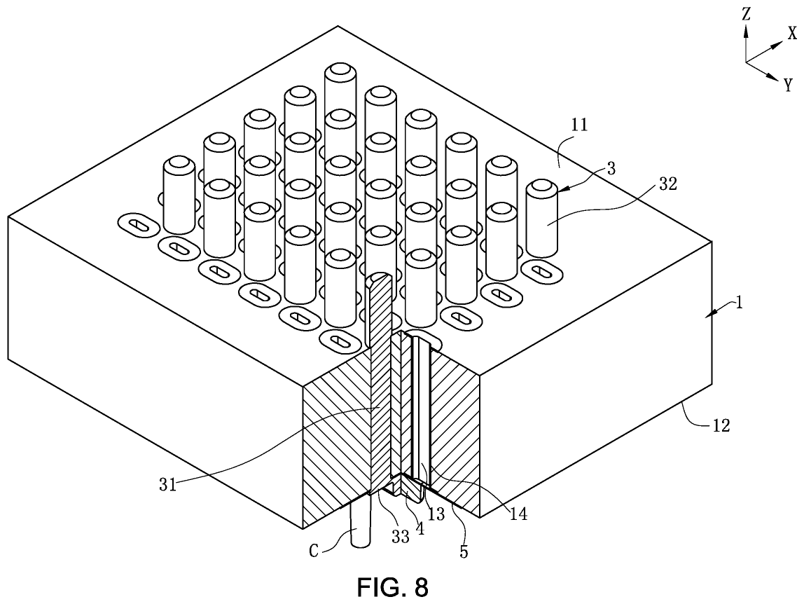

As shown in FIG. 8 to FIG. 10, in the step S2, each support member 3 forms the first portion 31 in each through hole 15, forms the second portion 32 below the inverted substrate 1 corresponding to each through hole 15, and forms the position limiting portion 33 above the inverted substrate 1 corresponding to each through hole 15. The size of a horizontal cross section of the position limiting portion 33 is smaller than or equal to the diameter of each through slot 51. The second portion 32 and the position limiting portion 33 are integrally connected to the upper end and the lower end of the first portion 31. The second portion 32 and the position limiting portion 33 respectively abut the substrate 1 in the vertical direction Z, thereby preventing each support member 3 from being subject to a force and moving in the vertical direction Z relative to the substrate 1.

As shown in FIG. 9, in step S3, the substrate 1, the support members 3, the connecting member 4, the insulating member 5 and the flow gate material C are taken out from the mold 6.

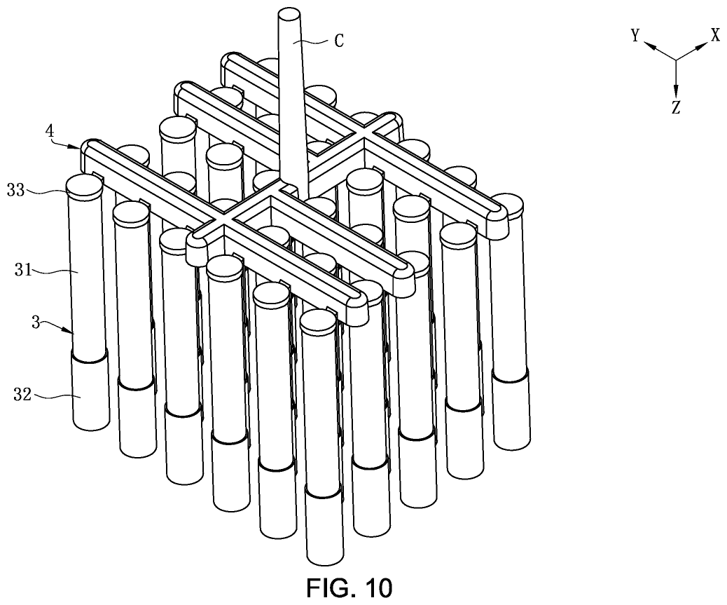

As shown in FIG. 10 to FIG. 13, then, the connecting member 4 is disconnected from the support members 3, and the connecting member 4 and the flow gate material C that are integrally connected are removed. Finally, the insulating member 5 is removed from the substrate 1.

As shown in FIG. 2, FIG. 3 and FIG. 14, in step S4, the first terminals 21 and the second terminals 22 made of a metal material are provided. Each first terminal 21 is provided with the first conducting portion 212 and the first contact portion 214 to be upward conductively connected to the first mating component 200, and each second terminal 22 is provided with the second conducting portion 222 and the second contact portion 224 to be downward conductively connected to the second mating component 300.

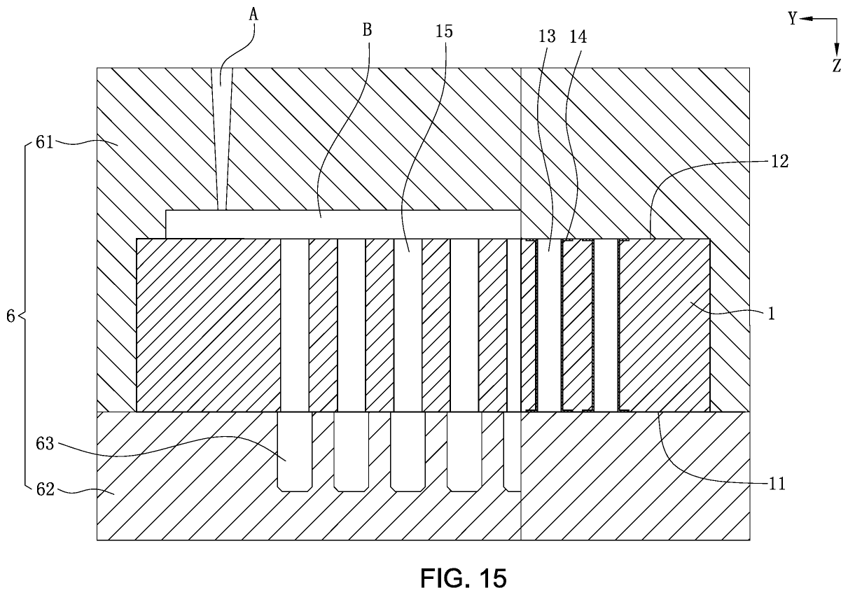

As shown in FIG. 2, FIG. 3 and FIG. 14, in the step S4, the first conducting portions 212 of the first terminals 21 are correspondingly inserted downward into the grooves 13 such that each first conducting portion 212 is in contact with the corresponding conductive portion 14 to form an electrical connection, and the second conducting portions 222 of the second terminals 22 are correspondingly inserted upward into the grooves 13 such that each second conducting portion 222 is in contact with the corresponding conductive portion 14 to form an electrical connection. FIG. 15 to FIG. 17 show a second embodiment of the present invention. The electrical connector 100 in this embodiment is substantially the same as the structure according to the first embodiment, and the differences therebetween exist in that: the electrical connector 100 further includes a connecting member 4. The connecting member 4 is integrally connected to the support members 3. The connecting member 4 is located below the substrate 1 and connected to the first portions 31 of the support members 3. The connecting member 4 and the support members 3 are injection-molded with the same plastic material, and the connecting member 4 serves as the position limiting portion in the first embodiment. That is, the connecting member 4 in this embodiment and the position limiting portion in the first embodiment provide the same function.

As shown in FIG. 15 to FIG. 17, the differences of the method of manufacturing the electrical connector 100 in this embodiment from that in the first embodiment exist in that: in the step S2, only the substrate 1 is inverted and disposed in the cavity 63 of the mold 6, such that when the upper mold 61 and the lower mold 62 are closed together, the upper mold 61 shields each conductive portion 14 downward from the upper side of the inverted substrate 1. The opening of the flow gate A gradually decreases downward from top thereof in the upper mold 61 and is funnel shaped. The runner B is located above the through holes 15 and is in downward communication with each through hole 15. After the liquid plastic is cooled, the diameter of an end of the flow gate material C formed in the flow gate A near the connecting member 4 is smaller than the diameter of the other end thereof away from the connecting member 4, and the flow gate material C is provided at the periphery of the grooves 13, thereby not preventing the second terminals 22 from being correspondingly mounted to the grooves 13 in the subsequent step S4.

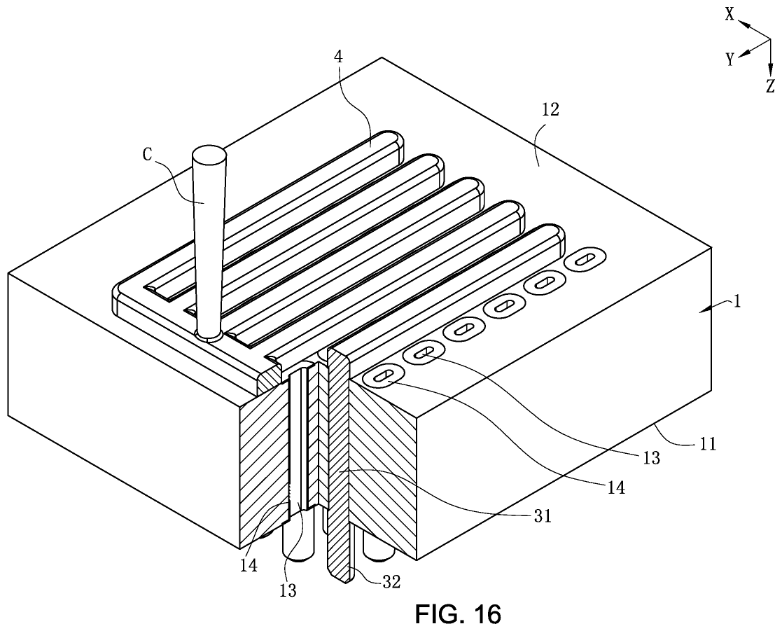

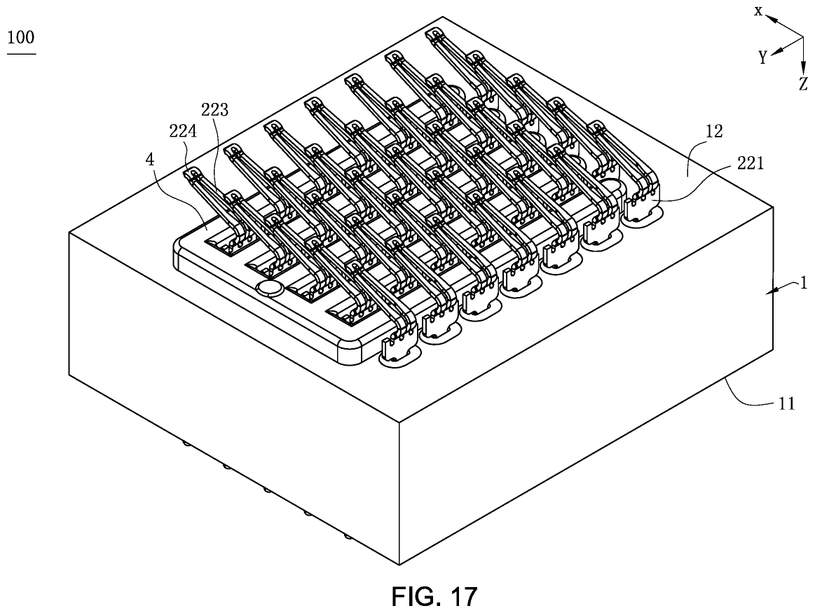

As shown in FIG. 16 to FIG. 17, FIG. 16 is a view of the liquid plastic after cooling, without showing the mold 6. In the step S3, the upper mold 61 and the lower mold 62 are separated. At this time, the flow gate material C is disconnected from the connecting member 4 at the joint thereof, and the substrate 1, the support members 3 and the connecting member 4 are taken out from the lower mold 62. The connecting member 4 upward abuts the lower surface 12 of the substrate 1. By the combined action of the second portion 32 and the connecting member 4, the support members 3 are prevented from moving vertically relative to the substrate 1, thereby ensuring the support members 3 not to detach from the substrate 1.

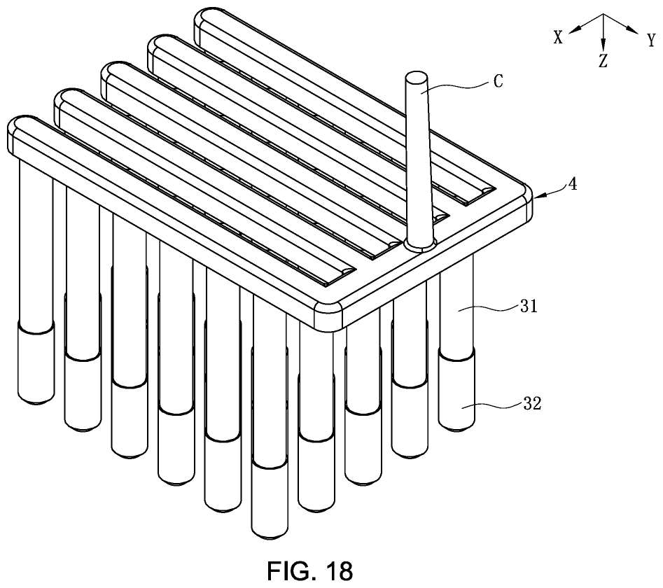

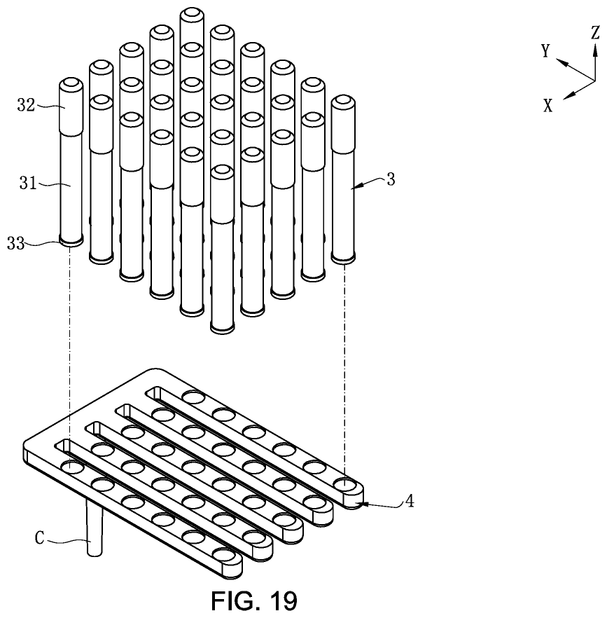

FIG. 18 and FIG. 19 show a third embodiment of the present invention. The third embodiment is substantially the same as the second embodiment, and the differences therebetween exist in that:

In step S3, the substrate 1, the support members 3, the connecting member 4 and the gate material C are taken out from the mold 6, and the connecting member 4 and the flow gate material C are removed together, such that the connecting member 4 is disconnected from the support members 3. Each support member 3 includes a position limiting portion 33 located below the substrate 1, and the position limiting portion 33 upward abuts the lower surface 12. After the connecting member 4 is removed, it is possible to recognize whether or not the molding method is employed according to the indentation of the lower surface 12.

To sum up, the electrical connector and the method of manufacturing the same according to certain embodiments of the present invention have the following beneficial effects:

1. By disposing the substrate 1 in the mold 6, and then injecting the liquid plastic into the mold 6, the liquid plastic flows into the through holes 14, the liquid plastic forms the connecting member 4 and the support members 3 integrally connected by the connecting member 4 after cooling, the support members 3 are correspondingly accommodated in the through holes 15 and protrude upward out of the substrate 1, and the connecting member 4 is located below the substrate 1. Thus, the support members 3 can be provided on the substrate 1 at a time, thereby eliminating the time for implanting the support members 3 one-by-one, saving the mounting time, saving the cost and enhancing the work efficiency.

2. Each support member 3 has the first portion 31, and the second portion 32 and the position limiting portion 33 connected to the upper and lower ends of the first portion 31. The first portion 31 is accommodated in a corresponding through hole 15, and the second portion 32 and the position limiting portion 33 respectively abut the substrate 1 in the vertical direction Z. Thus, when the support members 3 are subject to a downward pressure of the first mating component 200, the support members 3 can be prevented from being detached from the substrate 1 downward and from being detached from the substrate 1 upward.

3. The flow gate material C is funnel shaped, which facilitates the removal of the flow gate material C on the basis that the connecting member 4 remains connected to the support members 3 after the connecting member 4 is formed. By the combined action of the second portion 32 and the connecting member 4, the support members 3 are prevented from moving vertically relative to the substrate 1, thereby ensuring the support members 3 not to detach from the substrate 1.

4. The first terminals 21 and the second terminals 22 have identical structures, such that the first terminals 21 and the second terminals 22 can be formed by only one set of stamping equipment, thereby reducing the cost.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector configured to be electrically connected to a first mating component, comprising:
a substrate, provided with a plurality of conductive portions and a plurality of through holes, wherein the through holes run through the substrate vertically;
a plurality of first terminals, wherein each of the first terminals is provided with a first conducting portion and a first contact portion, the first conducting portion is downward conductively connected to a corresponding one of the conductive portions, and the first contact portion is located above the substrate to be conductively connected to the first mating component;
a plurality of support members, integrally injection-molded on the substrate and correspondingly accommodated in the through holes, wherein the support members protrude upward out of the substrate to support the first mating component; and
a connecting member, integrally connected to the support members, wherein the connecting member is located below the substrate.

2. The electrical connector according to claim 1, wherein each of the support members comprises a first portion and a second portion connected to each other, the first portion is accommodated in a corresponding one of the through holes, and the second portion is located above the substrate and pressed downward on the substrate.

3. The electrical connector according to claim 1, wherein an upper surface of the substrate is downward concavely provided with a plurality of grooves, a groove wall of each of the grooves is provided with one of the conductive portions, and the first conducting portion of each of the first terminals is a fisheye structure inserted into a corresponding one of the grooves to be electrically connected to the corresponding one of the conductive portions.

4. The electrical connector according to claim 1, further comprising a plurality of second terminals, wherein each of the second terminals is provided with a second conducting portion and a second contact portion, the conductive portions are respectively exposed upward and downward on the substrate, the second conducting portion is upward conductively connected to a corresponding one of the conductive portions, and the second contact portion is located below the substrate to be downward conductively connected to a second mating component.

5. The electrical connector according to claim 4, wherein the substrate is provided with a plurality of grooves running through the substrate vertically, a groove wall of each of the grooves is provided with one of the conductive portions, the first conducting portion of each of the first terminals is inserted downward into a corresponding one of the grooves and electrically connected to the corresponding one of the conductive portions, and the second conducting portion of each of the second terminals is inserted upward into a corresponding one of the grooves and electrically connected to the corresponding one of the conductive portions.

6. The electrical connector according to claim 4, wherein:
each of the first terminals comprises a first main body portion and a first elastic arm extending forward from the first main body portion, the first elastic arm is provided with the first contact portion, and the first conducting portion extends downward from the first main body portion; and
each of the second terminals comprises a second main body portion and a second elastic arm extending forward from the second main body portion, the second elastic arm is provided with the second contact portion, and the second conducting portion extends upward from the second main body portion.

7. The electrical connector according to claim 4, wherein one of the first terminals and one of the second terminals connected to a same one of the conductive portions are provided to be vertically symmetrical.

8. The electrical connector according to claim 1, wherein the first terminals comprise at least one ground terminal and at least one signal terminal, and the at least one ground terminal and the at least one signal terminal have identical structures.

9. An electrical connector configured to be electrically connected to a first mating component, comprising:
a substrate, provided with a plurality of conductive portions and a plurality of through holes, wherein the through holes run through the substrate vertically;
a plurality of first terminals, wherein each of the first terminals is provided with a first conducting portion and a first contact portion, the first conducting portion is downward conductively connected to a corresponding one of the conductive portions, and the first contact portion is located above the substrate to be conductively connected to the first mating component; and
a plurality of support members, integrally injection-molded on the substrate, wherein each of the support members has a first portion, and a second portion and a position limiting portion connected to an upper end and a lower end of the first portion, the first portion is accommodated in a corresponding one of the through holes, the second portion protrudes upward out of the substrate to support the first mating component, the position limiting portion is located below the substrate, and the second portion and the position limiting portion respectively abut the substrate in a vertical direction.

10. A method of manufacturing an electrical connector configured to be electrically connected to a first mating component, the method comprising:
step S1: providing a substrate, wherein the substrate is provided with a plurality of conductive portions and a plurality of through holes, and the through holes run through the substrate vertically;
step S2: disposing the substrate in a mold, and then injecting a liquid plastic into the mold, wherein the liquid plastic flows into the through holes, the liquid plastic forms a connecting member and a plurality of support members integrally connected by the connecting member after cooling, the support members are correspondingly accommodated in the through holes and protrude upward out of the substrate, and the connecting member is located below the substrate;
step S3: taking the substrate, the support members and the connecting member out from the mold; and
step S4: providing a plurality of first terminals, wherein each of the first terminals is provided with a first conducting portion and a first contact portion configured to be upward conductively connected to the first mating component; and making the first conducting portions of the first terminals to be downward conductively connected to the conductive portions correspondingly.

11. The method according to claim 10, wherein in the step S1, an insulating member is attached below the substrate, the insulating member comprises a plurality of through slots, each of the through slots runs through the insulating member vertically, the through slots correspond to the through holes vertically, and the insulating member shields the conductive portions.

12. The method according to claim 11, wherein after the step S3 and prior to the step S4, the insulating member and the connecting member are removed such that the connecting member is disconnected from the support members.

13. The method according to claim 10, wherein in the step S2, the mold comprises an upper mold, a lower mold and a cavity, the substrate is placed into the cavity, the upper mold and the lower mold are closed together, the mold shields each of the conductive portions, the cavity is in communication with each of the through holes, and the liquid plastic forms the connecting member and the support members in the cavity after cooling.

14. The method according to claim 13, wherein:
in the step S2, after the liquid plastic is cooled, a first portion is formed in each of the through holes, a second portion is formed above the substrate corresponding to each of the through holes, a position limiting portion is formed below the substrate corresponding to each of the through holes, the second portion and the position limiting portion are integrally connected to an upper end and a lower end of the first portion, and the second portion and the position limiting portion respectively abut the substrate in a vertical direction; and
after the step S3 and prior to the step S4, the connecting member is removed, such that the connecting member is disconnected from the support members.

15. The method according to claim 10, wherein:
in the step S1, the substrate is formed with a plurality of grooves running through the substrate vertically, and a groove wall of each of the grooves is provided with one of the conductive portions; and
in the step S4, a plurality of second terminals are provided, each of the second terminals is provided with a second conducting portion and a second contact portion configured to be downward conductively connected to a second mating component, and the first conducting portions of the first terminals and the second conducting portions of the second terminals are respectively inserted into the grooves and are in contact with the conductive portions to form electrical connections.
